(19) United States
(12) Patent Application Publication
(10) Pub. No.: US 2020/0003185 A1
(43) Pub. Date: Jan. 2, 2020

(54) WIND TURBINE APPARATUS

(71) Applicants: SAQR MAJED BIN SAQR AL MARRI, DUBAI (AE); SALEM SAQR MAJED BIN SAQR ALMARRI, DUBAI (AE)

(72) Inventor: Saqr Majed Bin Saqr Al Marri, Dubai (AE)

(21) Appl. No.: 16/022,122

(22) Filed: Jun. 28, 2018

(51) Int. Cl. F03D 13/40; F03D 3/06; F03D 9/32; F03D 9/34; F03D 9/25; B60L 8/00

(52) U.S. Cl. CPC F03D 13/40; B60L 2200/32; F03D 3/065; F03D 9/32; F03D 9/34; F03D 9/25; B60L 8/006; F05B 2240/941; F05B 2240/9112; F05B 2240/931; F05B 2240/21; F05B 2250/231; F05B 2260/02; F05B 2280/4002; F05B 2280/10; F03D 3/064

(57) ABSTRACT

There is provided a wind turbine apparatus, comprising a wind turbine structure and an enclosure structure, which is easily transportable and capable of being mounted on moving vehicles or buildings during operation of the wind turbine apparatus. The wind turbine structure generates electric power from kinetic energy of natural wind and comprises of a plurality of vertical blades arranged in a circular manner to form a plurality of rotatable and integrally superimposed cylindrical compartments. The enclosure structure provides support and rigidity to the wind turbine structure and comprises of a plate at one end of the housing, a closed hollow base portion at an other end of the enclosure and a plurality of connecting columns to mechanically hold together the plate and the closed hollow base portion. The wind turbine structure is placed within the enclosure structure and a connecting shaft connects the wind turbine structure to the enclosure structure.

### FIELD OF THE INVENTION

The present invention relates to the field of wind turbines, and more particularly, an enclosure structure for a wind turbine apparatus to enable the wind turbine to be mounted on vehicles or on buildings during operation of the wind turbine apparatus.

### BACKGROUND OF THE INVENTION

A wind turbine is a device which converts kinetic energy of the wind into electrical energy or mechanical power. This mechanical power is used directly or in combination with a generator for conversion of the power into electricity, which is then distributed for use in residential buildings or homes, offices, schools etc.

Wind being a renewable source can be harnesses and used to generate power, inexhaustibly and is sustainable. Generation of wind energy does not cause pollution and requires no additional operational costs, after installation.

Wind turbines rotate either about a horizontal axis or a vertical axis. However, irrespective of the axis of rotation, a wind turbine generally includes a rotor component, a generator component and a structural support for the turbine. The rotor component comprises a number of blades which convert the energy from the wind into rotational energy, i.e. the wind causes the blades to rotate, which causes a shaft to turn. This shaft is connected to the generator, which is then responsible for the conversion of the rotational energy from the rotor component into electricity. The blades of wind turbines rotate at varying velocities which results in varying efficiencies.

However wind turbines require regular maintenance in order to remain reliable and produce efficient ouputs. The maintenance process is tedious in the case of traditional wind turbine structures, due to the requirement of heavy cranes for lifting up maintenance tools or components, for example to reach the rotor component of the wind turbine. Further, installation of a new wind turbine is not a very easy process. Another disadvantage with traditional wind turbines is that wind turbines are only operational at certain locations where the speed of wind is relatively high. These locations usually tend to be areas which are remote and located away from cities and residential areas. Hence, extra investments are required to deliver or transfer the generated electricity to required locations. The set up of traditional wind turbines is expensive and the availability of an open area is a mandate in order for the set up. This has led to extensive deforestation occurrences. Even the setting up of a wind turbine in city or residential premises involves height restrictions and several other inconsistencies considering residential area regulations.

Accordingly, there exists a need to provide a portable wind turbine structure capable of being mounted on vehicles, which overcomes atleast a part of the above disadvantages and using lesser components, which are easier to maintain.

### SUMMARY OF THE INVENTION

Therefore it is an object of the present invention to provide a wind turbine apparatus which is easily transportable and capable of being mounted on vehicles or on buildings during operation of the wind turbine apparatus.

The present invention invloves an enclosure structure for a wind turbine comprising a cage—like portion to house a plurality of vertically arranged blades of the wind turbine, and a closed hollow base portion to house a generator, wherein the enclosure structure enables the wind turbine to be mounted horizontally on a moving vehicle for expedited generation of energy.

In another embodiment of the present invention, the enclosure structure further comprises a plate at one end of the enclosure structure, and a plurality of connecting columns forming the cage—like portion to mechanically hold together the plate and the closed hollow base portion, wherein the wind turbine is placed within the enclosure structure and a connecting shaft connects the wind turbine to the enclosure structure.

In another embodiment, a plurality of wheels are mechanically coupled to the closed hollow base portion of the enclosure structure to enable ease of transportation of the wind turbine.

In another embodiment, the plurality of connecting columns are positioned along a periphery of the plate and closed hollow base portion of the enclosure structure to minimize external vibrations affecting the wind turbine.

The present invention involves a wind turbine apparatus comprising a wind turbine structure to generate electric power from kinetic energy of natural wind comprising a plurality of rotatable and integrally superimposed cylindrical compartments, wherein a plurality of vertical blades arranged in a circular manner forms a cylindrical compartment and each cylindrical compartment is defined by a lower disk structure at a first end of the cylindrical compartment, and an upper disk structure at a second end of the cylindrical compartment, wherein the plurality of vertical blades pass through the upper and lower disk structures corresponding to each cylindrical compartment using a clipping mechanism.

The wind turbine apparatus further comprises an enclosure structure to provide support and rigidity to the wind turbine structure comprising a plate at one end of the enclosure structure, a closed hollow base at another end of the enclosure structure and a plurality of connecting columns to mechanically hold together the plate and the closed hollow base portion, wherein the wind turbine structure is placed within the enclosure structure and a connecting shaft connects the wind turbine structure to the enclosure structure.

In another embodiment, a lower disk structure of a first cylindrical compartment is an upper disk structure of a second cylindrical compartment and a lower disk structure of the second cylindrical compartment is an upper disk structure of a third cylindrical compartment, of the wind turbine structure.

In another embodiment, the plurality of vertical blades arranged in a circular manner are positioned at a specific and fixed angle to each other, to create a pressure difference within and outside the plurality of integrally superimposed cylindrical compartments during operation of the wind turbine apparatus.

In another embodiment, the plurality of integrally superimposed cylindrical compartments comprises at least one cylindrical compartment to form the wind turbine structure.

In another embodiment, a plurality of wheels are mechanically coupled to the closed hollow base portion of the enclosure structure to enable ease of transportation of the wind turbine apparatus.

In another embodiment, the connecting shaft rotates along with the plurality of rotatable integrally superimposed cylindrical compartments and is electrically connected to a generator located within the closed hollow base portion of the enclosure structure.

In another embodiment, the plurality of connecting columns are positioned along a periphery of the plate and closed hollow base portion of the enclosure structure to minimize external vibrations affecting the wind turbine apparatus.

In another aspect of the present invention, the wind turbine apparatus is coupled to a mobile transportation machine to generate electric power from kinetic energy of parallel and oppositely flowing wind.

In another embodiment, the mobile transportation machine is a vehicle or a marine vehicle.

In another aspect of the present invention, the wind turbine apparatus is coupled to a building to generate electric power from kinetic energy of natural wind.

Another aspect of the present invention describes a method of manufacturing a wind turbine apparatus, the method comprising providing a wind turbine structure to generate electric power from kinetic energy of natural wind comprising positioning a plurality of rotatable integrally superimposed cylindrical compartments, wherein a plurality of vertical blades arranged in a circular manner forms a rotatable cylindrical compartment and each rotatable cylindrical compartment is defined by a lower disk structure at a first end of the rotatable cylindrical compartment, and an upper disk structure at a second end of the rotatable cylindrical compartment, and fixing the plurality of vertical blades through the upper and lower disk structures corresponding to each cylindrical compartment using a clipping mechanism.

The method further comprises providing an enclosure structure to provide support and rigidity to the wind turbine structure comprising a plate at one end of the enclosure structure, a closed hollow base portion at the other end of the enclosure structure and a plurality of connecting columns to mechanically hold together the plate and the closed hollow base portion, wherein the wind turbine structure is placed within the enclosure structure and a connecting shaft connects the wind turbine structure to the enclosure structure.

In an embodiment, materials used for the plate and the closed hollow base portion of the enclosure structure comprise of wood.

In an embodiment, materials used for the plurality of connecting columns of the enclosure structure are comprised of steel, iron or aluminium.

In another embodiment, the plurality of vertical blades and the upper and lower disk structures of the wind turbine structure comprise of lightweight materials with high tensile strength and high resistance to wind pressure variations.

In another embodiment, the clipping mechanism enables easy replacement of any damaged blade within the plurality of vertical blades.

Additional advantages, objects, and features of the invention will be set forth in part in the description which follows and in part will become apparent to those having ordinary skill in the art upon examination of the following or may be learned from practice of the invention.

### BRIEF DESCRIPTION OF THE DRAWINGS

The subject matter that is regarded as the invention is particularly pointed out and distinctly claimed in the claims at the conclusion of the specification. The foregoing and other aspects, features, and advantages of the invention are apparent from the following detailed description taken in conjunction with the accompanying drawings in which:

FIG. 1 shows a wind turbine structure in accordance with the present invention;

FIG. 2 shows a block diagram in accordance with the present invention;

FIG. 3 depicts a clipping mechanism in accordance with the present invention;

FIG. 4 illustrates an implementation of the present invention coupled to a moving vehicle;

FIG. 5 illustrates an implementation of the present invention coupled to a moving marine vehicle.

### DETAILED DESCRIPTION OF THE INVENTION

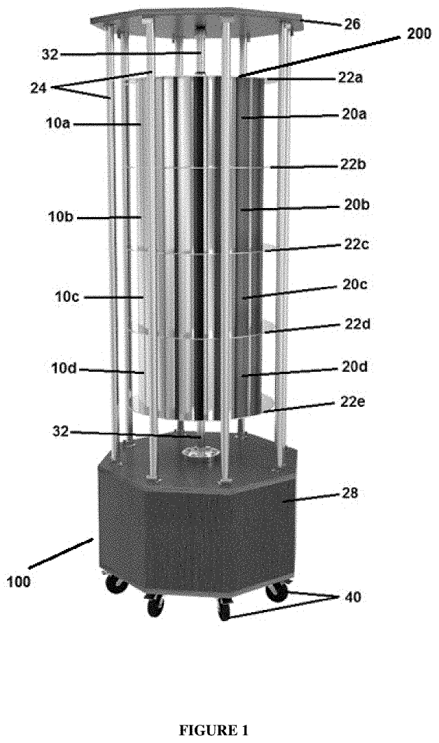

The aspects of the wind turbine apparatus according to the present invention will be described in conjunction with FIGS. 1-4.

The wind turbine apparatus according to the present invention provides a solution to the disadvantages faced by traditional wind turbines in terms of maintenance, installation and operation. The wind turbine apparatus according to the present invention involves placing a wind turbine structure within an enclosure structure, which is portable and capable of being mounted on a vehicle or on buildings. This is in order to eliminate any obstacles faced during installation and operation of wind turbines, such as required area for installation or operation, allowable height of the wind turbine and residential regulations. The proposed enclosure structure comprises a cage—like portion to house a plurality of vertically arranged blades of the wind turbine and a closed hollow base portion to house a generator. The enclosure structure enables the wind turbine to be mounted horizontally on a moving vehicle for expedited generation of energy.

In accordance with an embodiment of the invention, the wind turbine apparatus includes a wind turbine structure and an enclosure structure. The wind turbine structure comprises of a plurality of vertical blades arranged in a circular manner, forming a cylindrical compartment. The cylindrical compartment is defined by a lower disk structure at a first end of the cylindrical compartment, and an upper disk structure at a second end of the cylindrical compartment. This cylindrical compartment is placed within the enclosure structure and connected to the enclosure structure using a connecting shaft. The enclosure structure provides support to the wind turbine structure.

As per a preferred embodiment of the present invention and referring to FIG. 1, a plurality of cylindrical compartments (10a-10d) are integrally superimposed on each other, forming multiple rows of circularly arranged vertical blades (20a-20d) which results in formation of the wind turbine structure. The plurality of vertical blades (20a-20d) arranged in a circular manner are preferably positioned at a specific but fixed angle to each other, to aid in creating a pressure difference within and outside the plurality of cylindrical compartments (10a-10d) during operation of the wind turbine apparatus. Each cylindrical compartment in the plurality of cylindrical compartments (10a-10d) is defined by the presence of an upper disk structure at a first end of the cylindrical compartment, and a lower disk at a second end of the cylindrical compartment. The plurality of cylindrical compartments are then integrally superimposed on each other, to form the wind turbine structure—through connections made between the disk structures associated with each cylindrical compartment. As depicted in FIG. 1, the lower disk structure 22b of the first cylindrical compartment 10a is the upper disk structure of the second cylindrical compartment 10b, the lower disk structure 22c of the second cylindrical compartment 10b is the upper disk structure of the third cylindrical compartment 10c, and so on. The number of integrally superimposed cylindrical compartments comprises at least one cylindrical compartment to form the wind turbine structure. The connecting shaft 32 connects the plurality of integrally superimposed cylindrical compartments (10a-10d) which form the wind turbine structure 200, to the enclosure structure 100 which provides support to the wind turbine structure 200. This connecting shaft 32 is capable of rotation along with rotation of the plurality of integrally superimposed cylindrical compartments (10a-10d).

The number of circularly arranged vertical blades (20a-20d) in each cylindrical compartment of the wind turbine structure 200 is variable based on requirements and increases with an increase in the diameter of the cylindrical compartment designed. Further, it is required that the materials used for the circularly arranged vertical blades have high tensile strength, high resistance to wind pressure and pressure variations and that the material used should be lightweight. The angular arrangement of the circularly arranged vertical blades (20a-20d) wherein the plurality of vertical blades (20a-20d) are positioned at a specific but fixed angle to each other leads to an overall increase in the rotation speed and ultimately an improvement in the total output or efficiency of the wind turbine structure. Another feature of the proposed wind turbine structure 200 which further contributes to the overall performance of the wind turbine apparatus is that the circularly arranged vertical blades (20a-20d) are fixed on either ends to upper and lower disk structures associated with each cylindrical compartment, which results in the vertical blades of the present invention being more efficient and resistant to wind pressure, in comparison to blades of traditional wind turbines. The requirements with regard to the materials used for the upper and lower disk structures (22a-22e) corresponding to each cylindrical compartment are similar to that of the circularly arranged vertical blades since rotation of the upper and lower disk structures is in accordance with the movement of the circularly arranged vertical blades present in each cylindrical compartment.

The enclosure structure 100 within which the wind turbine structure 200 is placed, comprises a plate 26 at one end of the enclosure structure 100 and a closed hollow base portion 28 at the other end of the enclosure structure 100. The plate 26 and the closed hollow base portion 28 are connected through a plurality of connecting columns 24 which may vary in number and length, based on the size of the wind turbine structure 200. The plate 26, the closed hollow base portion 28 and the plurality of connecting columns 24, are mechanically held together through a plurality of screws 30, which connect each connecting column 24 to the plate 26 and the closed hollow base portion 28. The wind turbine structure 200 is placed within the enclosure structure 100 and connected to the enclosure structure 100 using the connecting shaft 32. The connecting columns 24 are arranged along a periphery of the plate 26 and closed hollow base portion 28, thus minimizing possible vibrations, acting as a support and providing rigidity to the wind turbine structure 200.

In an embodiment of the present invention, plate 26 is supported using a plurality of ropes in the form of supporting mechanism from the plate 26 of the wind turbine enclosure structure 100 to the ground, the plurality of ropes being used in the same manner that tents are generally fixed to the ground using ropes as a supporting mechanism.

A further advantage of the connecting columns 24 involves the flexibility of mounting or coupling the wind turbine apparatus either horizontally or vertically, on surfaces which include moving vehicles or on buildings. This structural arrangement paves the way for ease of installation and maintenance, and for improved operation of the wind turbine apparatus. The enclosure structure 100 which includes a plurality of connecting columns 24 also aids in helping the wind turbine apparatus to withstand strong gusts of wind, resulting in higher performance capability of the wind turbine without risking the apparatus itself to damage.

The enclosure structure 100 can be made of any suitable material. In a preferred embodiment of the present invention, the plate 26 and the closed hollow base portion 28 are made of wood, and the plurality of connecting columns 24 and the screws 30 are comprised of steel, iron or aluminum. In an embodiment of the present invention, the type of wood used for the plate 26 and the closed hollow base portion 28 is marine wood, a water-proof type of wood used to withstand heat, moisture and humidity. As an alternative to the marine wood used, aluminium or iron is also used.

The plurality of integrally superimposed cylindrical compartments (10a-10d) formed by the multiple rows of circularly arranged vertical blades (20a-20d) is the rotor component of our wind turbine structure 200, which converts kinetic energy from natural wind into rotational energy. A centre or interior portion of the plurality of integrally superimposed cylindrical compartments (10a-10d) is empty or hollow. Hence, in accordance with the present invention, during operation of the wind turbine apparatus, natural wind causes the plurality of integrally superimposed cylindrical compartments (10a-10d) to rotate which in turn causes the connecting shaft 32 to turn. The connecting shaft 32 is further electrically connected to a generator or an alternator (not shown), which is located within the closed hollow base portion 28 of the enclosure structure 100. A further advantage to enclosing a generator or an alternator within the closed hollow base portion 28 of the enclosure structure 100 includes that the generator or alternator will remain safe from any dust or impurities which may affect its overall functioning.

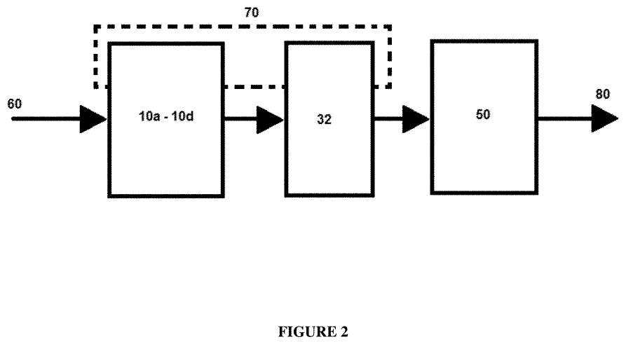

The generator or alternator is responsible for conversion of the rotational energy from the plurality of integrally superimposed cylindrical compartments (10a-10d) into electricity. The multiple rows of circularly arranged vertical blades (20a-20d) are capable of rotating at varying velocities depending on fluctuating speed and force of the natural wind, which results in the wind turbine yielding varying efficiencies. FIG. 2 is a block diagram depicting the conversion of natural wind 60 to energy or electricity 80, through rotation of the plurality of integrally superimposed cylindrical compartments (10a-10d) and the connecting shaft 32. As shown in FIG. 2, kinetic energy from natural wind 60 leads to rotation of the plurality of integrally superimposed cylindrical compartments (10a-10d) which in turn leads to rotation of the connecting shaft 32 due to the formation of rotational energy 70. The connecting shaft 32 is further electrically connected to the generator depicted as 50, and the generator 50 converts the rotational energy 70 into energy or electricity 80.

The direction of rotation of the plurality of integrally superimposed cylindrical compartments (10a-10d) depends on the direction in which the natural wind flowing through the wind turbine. However, regardless of the direction in which the plurality of integrally superimposed cylindrical compartments (10a-10d) rotates, rotation of the plurality of integrally superimposed cylindrical compartments (10a-10d) will cause the connecting shaft 32 to turn which will result in the generator or alternator generating electricity or electrical energy or mechanical power.

The wind turbine structure electrically connected to a generator or alternator generates electricity. The turning motion of the connecting shaft 32 causes a rotor of the generator or alternator (not shown) to rotate, thus creating electromagnetic induction and thereby generating electricity. The generated electricity is then passed through a transformer (not shown) to increase the voltage, or through power stations to decrease the voltage.

In an embodiment of the present invention, a plurality of wheels 40 are mechanically fixed or coupled to the bottom of the closed hollow base portion 28 of the enclosure structure 100, enabling the wind turbine structure to be easily transported and maintained.

In another embodiment of the present invention, there are eight connecting columns 24 mechanically hold together through a plurality of screws 30, the plate 26 and the closed hollow base portion 28 of the enclosure structure 100 which encloses a wind turbine structure 200 connected to the enclosure structure 100 using a connecting shaft 32. In this embodiment, the plate 26 and the closed hollow base portion 28 of the enclosure structure 100 are octagonal in shape with the screws 30 located at each of the eight corners of the plate 26 and the closed hollow base portion 28 of the enclosure structure 100. Presence of the connecting column 24 along the periphery of the plate 26 and closed hollow base portion 28 provides the flexibility of implementing the wind turbine apparatus vertically or horizontally—as per requirement and space availability.

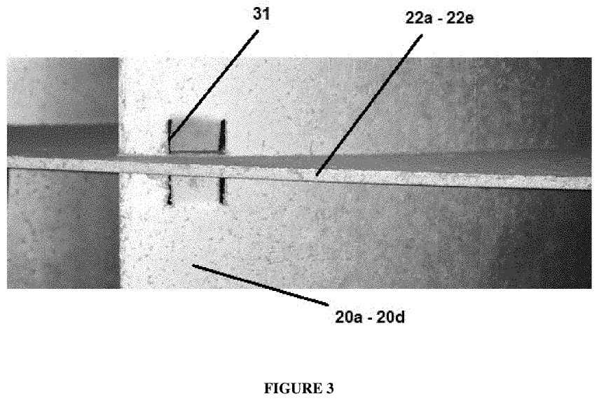

In another preferred embodiment of the present invention, and as depicted in FIG. 3, the wind turbine structure 200 is designed such that the circularly arranged vertical blades (20a-20d) pass through the upper and lower disk structures (22a-22e) or horizontal blades corresponding to each cylindrical compartment using a clipping mechanism, and are fixed in position avoiding requirements of any welding procedures. Owing to the clipping mechanism employed by the blades, which is a cut 31 made on the blades to facilitate clipping between the vertical and horizontal blades there is no need for welding procedures to be performed while designing or manufacturing the wind turbine structure in accordance with the present invention.

A further advantage of the clipping mechanism is based on the fact that any blade within the plurality of vertical blades (20a-20d) may be easily and rapidly replaced if damaged or weakened during the course of operation of the wind turbine apparatus, instead of replacing the apparatus as a whole. This easy and quick replacement is not possible if the plurality of blades are welded together.

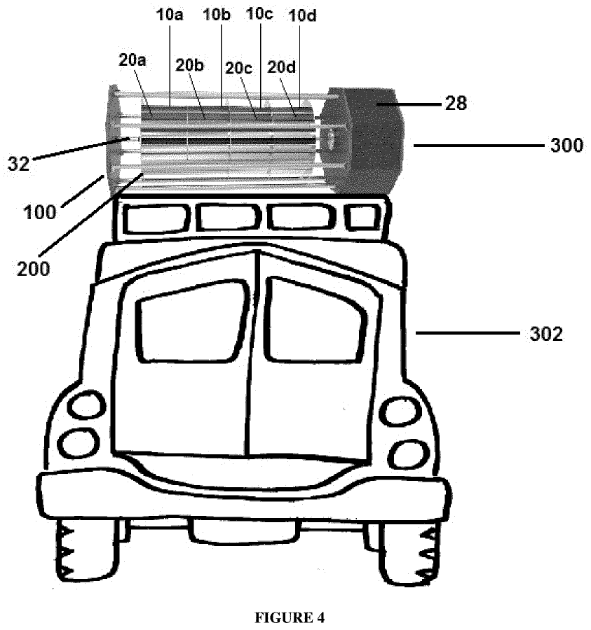

The housing structure and wind turbine structure in accordance with the present invention leads to the implementation of the wind turbine apparatus in a wide range of applications. A preferred embodiment of the present invention involves the implementation of the wind turbine apparatus on a moving vehicle. As illustrated in FIG. 4, the wind turbine apparatus 300 is placed or coupled horizontally or vertically on a moving vehicle 302. As the vehicle 302 moves forward, parallel and oppositely flowing strong winds will perpendicularly hit the multiple rows of circularly arranged vertical blades (20a-20d) of the wind turbine structure 200, resulting in the rotation of the circularly arranged vertical blades (20a-20d). This rotation of the circularly arranged vertical blades (20a-20d) or plurality of integrally superimposed cylindrical compartments (10a-10d) will cause the connecting shaft 32 to turn which will result in the generator or alternator located within the closed hollow base portion 28 of the housing structure 100 to generate electricity. Vehicles moving at higher speeds will result in generating higher amounts of electricity or electric power.

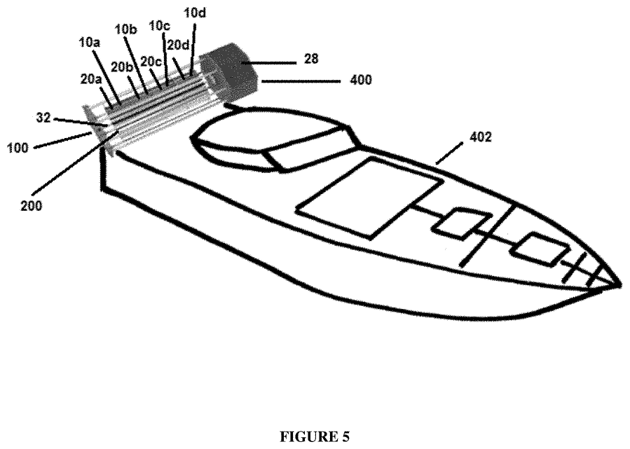

Another embodiment of the present invention includes implementation of the wind turbine apparatus on a moving marine vehicle, a boat or a ship. As illustrated in FIG. 5, the wind turbine apparatus 400 is placed or coupled horizontally or vertically on a moving boat 402. As the boat 402 moves forward, parallel and oppositely flowing strong winds will perpendicularly hit the multiple rows of circularly arranged vertical blades (20a-20d) of the wind turbine structure 200, resulting in the rotation of the circularly arranged vertical blades (20a-20d). This rotation of the circularly arranged vertical blades (20a-20d) or plurality of integrally superimposed cylindrical compartments (10a-10d) will cause the connecting shaft 32 to turn which will result in the generator or alternator located within the closed hollow base portion 28 of the enclosure structure 100 to generate electricity. Boats moving at higher speeds will result in generating higher amounts of electricity or electric power particularly considering that the intensity of winds at sea or coastal area are relatively high or strong.

Another embodiment of the present invention includes implementation of the wind turbine apparatus coupled to a building or skyscraper. The wind turbine apparatus is placed or coupled horizontally or vertically on a high building. Horizontal movement of free wind will hit the multiple rows of circularly arranged vertical blades (20a-20d) of the wind turbine structure 200, resulting in the rotation of the circularly arranged vertical blades (20a-20d). This rotation of the circularly arranged vertical blades (20a-20d) or plurality of integrally superimposed cylindrical compartments (10a-10d) will cause the connecting shaft 32 to turn which will result in the generator or alternator located within the closed hollow base portion 28 of the enclosure structure 100 to generate electricity. The wind turbine apparatus positioned on higher buildings will result in generating higher amounts of electricity or electric power, particularly considering that wind pressure increases with height.

In accordance with a further aspect of the present invention, a method of manufacturing a wind turbine apparatus is disclosed. The method comprises providing a wind turbine structure to generate electric power from kinetic energy of natural wind, which comprises positioning a plurality of rotatable integrally superimposed cylindrical compartments, wherein a plurality of vertical blades arranged in a circular manner forms a rotatable cylindrical compartment and each rotatable cylindrical compartment is defined by a lower disk structure at a first end of the rotatable cylindrical compartment, and an upper disk structure at a second end of the rotatable cylindrical compartment.

The method further includes steps of providing an enclosure structure to provide support and rigidity to the wind turbine structure which comprises a plate at one end of the enclosure structure, a closed hollow base portion at the other end of the enclosure structure and a plurality of connecting columns to mechanically hold together the plate and the closed hollow base, wherein the wind turbine structure is placed within the enclosure structure and a connecting shaft connects the wind turbine structure to the enclosure structure.

In accordance with another embodiment of the present invention, the wind turbine apparatus is provided as a kit wherein a plurality of rotatable integrally superimposed cylindrical compartments are present. Any number of cylindrical compartments may be superimposed on each other to form a wind turbine structure of variable lengths depending on the requirement and placement of the wind turbine apparatus.

Many changes, modifications, variations and other uses and applications of the subject invention will become apparent to those skilled in the art after considering this specification and the accompanying drawings, which disclose the preferred embodiments thereof. All such changes, modifications, variations and other uses and applications which do not depart from the spirit and scope of the invention are deemed to be covered by the invention, which is to be limited only by the claims which follow.

1. An enclosure structure for a wind turbine comprising:
a cage—like portion to house a plurality of vertically arranged blades of the wind turbine; and
a closed hollow base portion to house a generator;
wherein the enclosure structure enables the wind turbine to be mounted horizontally on a moving vehicle for expedited generation of energy.

2. The enclosure structure of claim 1 further comprising:
a plate at one end of the enclosure structure; and
a plurality of connecting columns forming the cage—like portion to mechanically hold together the plate and the closed hollow base portion,
wherein the wind turbine is placed within the enclosure structure; and
a connecting shaft connects the wind turbine to the enclosure structure.

3. The enclosure structure of claim 1 wherein, a plurality of wheels are mechanically coupled to the closed hollow base portion of the enclosure structure to enable ease of transportation of the wind turbine.

4. The enclosure structure of claim 2 wherein, the plurality of connecting columns are positioned along a periphery of the plate and closed hollow base portion of the enclosure structure to minimize external vibrations affecting the wind turbine.

5. A wind turbine apparatus, comprising:
a wind turbine structure to generate electric power from kinetic energy of natural wind comprising:
a plurality of rotatable and integrally superimposed cylindrical compartments,
wherein a plurality of vertical blades arranged in a circular manner forms a cylindrical compartment and each cylindrical compartment is defined by a lower disk structure at a first end of the cylindrical compartment, and an upper disk structure at a second end of the cylindrical compartment; and
wherein the plurality of vertical blades pass through the upper and lower disk structures corresponding to each cylindrical compartment using a clipping mechanism;
an enclosure structure to provide support and rigidity to the wind turbine structure comprising:
a plate at one end of the enclosure structure;
a closed hollow base portion at an other end of the enclosure structure; and
a plurality of connecting columns to mechanically hold together the plate and the closed hollow base portion,
wherein the wind turbine structure is placed within the enclosure structure; and
a connecting shaft connects the wind turbine structure to the enclosure structure.

6. The wind turbine apparatus of claim 5 wherein, a lower disk structure of a first cylindrical compartment is an upper disk structure of a second cylindrical compartment and a lower disk structure of the second cylindrical compartment is an upper disk structure of a third cylindrical compartment, of the wind turbine structure.

7. The wind turbine apparatus of claim 5 wherein, the plurality of vertical blades arranged in a circular manner are positioned at a specific and fixed angle to each other, to create a pressure difference within and outside the plurality of integrally superimposed cylindrical compartments during operation of the wind turbine apparatus.

8. The wind turbine apparatus of claim 5 wherein, the plurality of integrally superimposed cylindrical compartments comprises at least one cylindrical compartment to form the wind turbine structure.

9. The wind turbine apparatus of claim 5 wherein, a plurality of wheels are mechanically coupled to the closed hollow base portion of the enclosure structure to enable ease of transportation of the wind turbine apparatus.

10. The wind turbine apparatus of claim 5 wherein, the connecting shaft rotates along with the plurality of rotatable integrally superimposed cylindrical compartments and is electrically connected to a generator located within the closed hollow base portion of the enclosure structure.

11. The wind turbine apparatus of claim 5 wherein, the plurality of connecting columns are positioned along a periphery of the plate and closed hollow base portion of the enclosure structure to minimize external vibrations affecting the wind turbine apparatus.

12. The wind turbine apparatus of claim 5 wherein, the wind turbine apparatus is coupled to a mobile transportation machine to generate electric power from kinetic energy of parallel and oppositely flowing wind.

13. The wind turbine apparatus of claim 12 wherein, the mobile transportation machine is a vehicle or a marine vehicle.

14. The wind turbine apparatus of claim 5 wherein, the wind turbine apparatus is coupled to a building to generate electric power from kinetic energy of natural wind.

15. A method of manufacturing a wind turbine apparatus, the method comprising:
providing a wind turbine structure to generate electric power from kinetic energy of natural wind comprising:
positioning a plurality of rotatable integrally superimposed cylindrical compartments,
wherein a plurality of vertical blades arranged in a circular manner forms a rotatable cylindrical compartment; and
each rotatable cylindrical compartment is defined by a lower disk structure at a first end of the rotatable cylindrical compartment, and an upper disk structure at a second end of the rotatable cylindrical compartment; and
fixing the plurality of vertical blades through the upper and lower disk structures corresponding to each cylindrical compartment using a clipping mechanism;
providing an enclosure structure to provide support and rigidity to the wind turbine structure comprising:
a plate at one end of the enclosure structure;
a closed hollow base portion at the other end of the enclosure structure; and
a plurality of connecting columns to mechanically hold together the plate and the closed hollow base portion,
wherein the wind turbine structure is placed within the enclosure structure; and
a connecting shaft connects the wind turbine structure to the enclosure structure.

16. The method of claim 15 wherein, materials used for the plate and the closed hollow base portion of the enclosure structure comprise of wood.

17. The method of claim 15 wherein, materials used for the plurality of connecting columns of the enclosure structure are comprised of steel, iron or aluminium.

18. The method of claim 15 wherein, the plurality of vertical blades and the upper and lower disk structures of the wind turbine structure comprise of lightweight materials with high tensile strength and high resistance to wind pressure variations.

19. The method of claim 15 wherein, the clipping mechanism enables easy replacement of any damaged blade within the plurality of vertical blades.
